(19) United States
(12) Patent Application Publication
(10) Pub. No.: US 2019/0347677 A1
(43) Pub. Date: Nov. 14, 2019

(54) ADDICTIONS RECOVERY NETWORK REFERRAL TOOL

(71) Applicant: INDIANA UNIVERSITY RESEARCH AND TECHNOLOGY CORPORATION, Indianapolis, IN (US)

(72) Inventors: Robin P. Newhouse, Indianapolis, IN (US); Robert Skipworth Comer, Carmel, IN (US); Hannah Louise Maxey, Fishers, IN (US)

(21) Appl. No.: 16/408,119

(22) Filed: May 9, 2019

Related U.S. Application Data
(60) Provisional application No. 62/669,139, filed on May 9, 2018.

(51) Int. Cl. G06Q 30/02; G06F 16/23; G06F 16/28; G06F 16/9535; G06F 16/9538

(52) U.S. Cl. CPC G06Q 30/0203; G06F 16/2379; G06F 16/9538; G06F 16/9535; G06F 16/285

(57) ABSTRACT

Techniques are disclosed for providing an addiction recovery referral service. A method includes obtaining treatment center data indicative of one or more treatment centers, generating, as a function of survey data obtained for each of the one or more treatment centers, supplemental data regarding each of the one or more treatment centers, updating the treatment center data with the supplemental data, and populating a database with the updated treatment center data. Storage media and computing servers are also disclosed.

### CROSS-REFERENCE TO RELATED APPLICATIONS

The present disclosure claims the benefit of U.S. Provisional Patent Application Ser. No. 62/669,139, entitled “Addictions Recovery Network Referral Tool,” filed May 9, 2018. The entire contents of the priority document are incorporated herein by reference, except that in the event of any inconsistent disclosure or definition from the present specification, the disclosure or definition herein shall be deemed to prevail.

### GOVERNMENT LICENSE RIGHTS

This invention was made with government support under UL1TR001108 awarded by the National Institutes of Health. The government has certain rights in the invention.

### BACKGROUND

Referral networks for individuals in need of treatment for alcohol and drug addiction are often inadequate. Consequently, many patients might not be referred for treatment. Clinicians struggle to identify organizations to which to refer patients, since decisions typically depend on factors such as substance use, location, personal characteristics, and insurance type associated with the patient. For instance, in acute care settings nationally, a considerable number of admitted patients screen positive for high-risk drinking or non-prescription drug use, and many in-patient stays are primarily due to a behavioral health or substance use disorder. These high rates of substance use underscore considerable preventable health risks and an urgent need to advance behavioral health care practices.

### SUMMARY

The scope of the present invention is defined solely by the appended claims, and is not affected to any degree by the statements within this summary.

One embodiment presented herein discloses a computer-implemented method for providing network referrals to a patient in need thereof. The method generally includes obtaining, by execution of one or more processors, treatment center data indicative of one or more treatment centers and generating, as a function of survey data obtained for each of the one or more treatment centers, supplemental data regarding each of the one or more treatment centers. The treatment center data is updated with the supplemental data, and a database is populated with the updated treatment center data.

Another embodiment presented herein discloses one or more computer-readable storage media comprising instructions, which, when executed on one or more processors, performs an operation. The operation itself generally includes obtaining treatment center data indicative of one or more treatment centers and generating, as a function of survey data obtained for each of the one or more treatment centers, supplemental data regarding each of the one or more treatment centers. The treatment center data is updated with the supplemental data, and a database is populated with the updated treatment center data.

Yet another embodiment presented herein discloses a computing server having one or more processors and a memory storing program code. The program code, when executed on the one or more processors, performs an operation. The operation itself generally includes obtaining treatment center data indicative of one or more treatment centers and generating, as a function of survey data obtained for each of the one or more treatment centers, supplemental data regarding each of the one or more treatment centers. The treatment center data is updated with the supplemental data, and a database is populated with the updated treatment center data.

### BRIEF DESCRIPTION OF THE DRAWINGS

FIG. 1 illustrates an example of a representative computing environment providing a treatment center referral tool, according to an embodiment;

FIG. 2 illustrates an example of a representative computing server configured to provide a treatment center referral tool, according to an embodiment;

FIG. 3 illustrates an example of a representative graphical user interface that may be provided via a web service by the computing server of FIGS. 1 and 2, according to an embodiment;

FIG. 4 illustrates an example of a flow diagram of a representative method for building a database of treatment center data used for the treatment center referral tool of FIG. 1; and

FIG. 5 illustrates an example of a flow diagram of a representative method for providing treatment center options responsive to a search query via the treatment center referral tool of FIG. 1.

### DETAILED DESCRIPTION

Embodiments presented herein disclose techniques for identifying treatment options (e.g., for alcohol addiction and/or substance abuse) to allow clinicians to prepare treatment plans. More particularly, embodiments provide a software-based resource for an individual user (e.g., an administrator, clinician, patient, etc.) that accesses a database built using information about substance recovery programs and centers. The information may be generated from, e.g., publicly available data, such as Substance Abuse and Mental Health Services Administration (SAMHSA) data. Further, the database may include location information about treatment centers, such that the software-based resource may identify programs for at-risk patients based on proximity and specified parameters (e.g., desired program features). Such information may then be provided to a patient, e.g., as a printout or a display on a device. In some embodiments, the information may be implemented as a location-based listing of recovery services in which the listing provides a reference for health care providers who can then recommend a follow-up care to a patient. The listing may organize the information in various manners, such as by nearest location or contact information.

Further, in some embodiments, the software-based resource may track an amount of people who receive treatment, as well as underlying workforce changes associated with treatment centers. In doing so, the software-based resource may advantageously preserve anonymity of a given patient by not collecting identifying information of the patient.

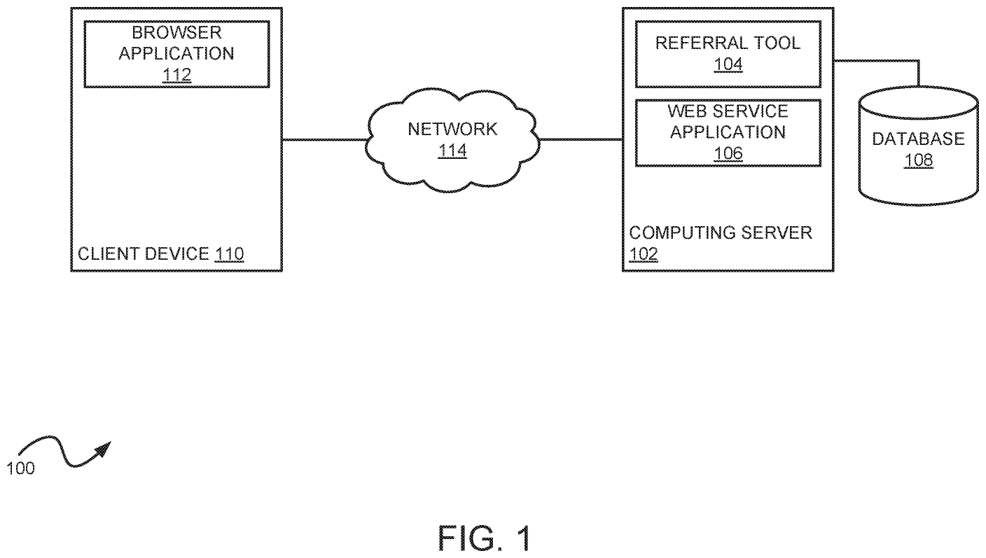

Referring now to FIG. 1, a computing environment 100 providing a treatment center referral tool is shown, according to at least one embodiment. As shown, the computing environment 100 includes a computing server 102 and a client device 110 interconnected via a network, such as a local area network (LAN), wide area network (WAN), and the Internet. The computing server 102 may be embodied as a physical computing system, such as a desktop computer, workstation in a data center, laptop computer, and so on. In other cases, the computing server 102 may be embodied as a virtual computing instance in a cloud network. Further, the client device 110 may be embodied as a physical computing system, such as a desktop computer, mobile device (e.g., a smartphone, tablet computer, wearable device, etc.), and so on. In other cases, the client device 110 may be embodied as a virtual computing instance in the cloud network.

The illustrative computing server 102 includes a referral tool 104, a web service application 106, and a database 108. The referral tool 104 may be embodied as any device or circuitry used to provide information regarding treatment referral networks to a requesting entity, such as via a browser application 112 executing on the client device 110. The referral tool 104 may build and connect with the database 108, which provides treatment center information within a referral network. More particularly, the database 108 provides a location-based listing of recovery services and centers for patients who may be in need of help with alcohol and/or substance abuse issues. The listing may provide a reference for health care providers who can recommend follow-up care to patients in need of such recovery services. Further, the referral tool 104 may communicate with a web service application 106, which is accessible by the browser application 112. The web service application 106 may be embodied as any software or circuitry to provide an interface (e.g., a web interface) for the client device 110 to access treatment center data stored in the database 108.

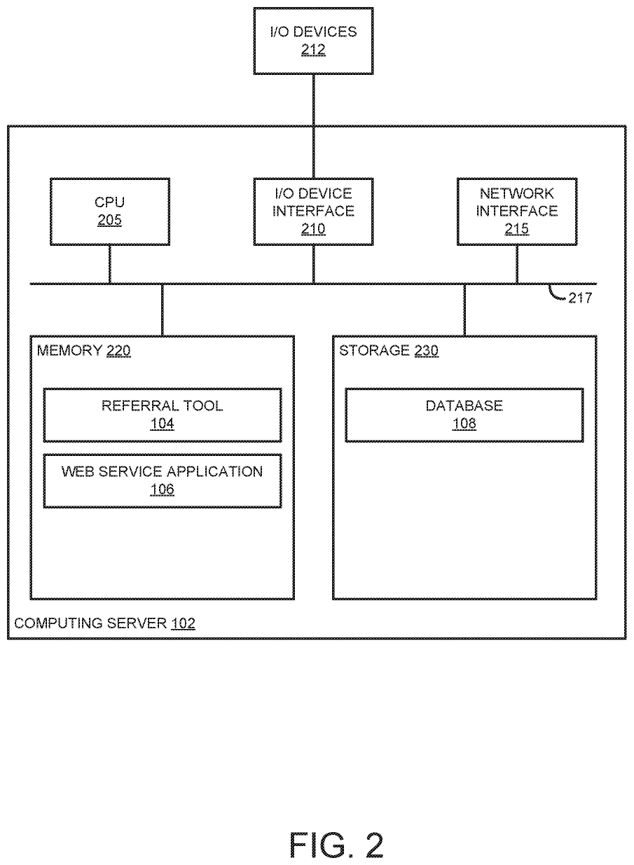

Referring now to FIG. 2, the computing server 102 includes, without limitation, a central processing unit (CPU) 205, an I/O device interface 210, a network interface 215, a memory 220, and a storage 230, each interconnected via an interconnect bus 217. It is to be understood that CPU 205 may be a single CPU, multiple CPUs, a single CPU having multiple processing cores, and/or the like. Memory 220 is generally included to be representative of a random access memory. Storage 230 may be a disk drive storage device. Although shown as a single unit, storage 230 may be a combination of fixed and/or removable storage devices, such as fixed disc drives, removable memory cards, optical storage devices, network attached storage (NAS), or a storage area network (SAN). The I/O device interface 210 may provide a communications interface between the computing server 102 and I/O devices 212. The I/O devices 212 may be embodied as any type of input/output device connected with or provided as a component to the computing server 102. Example I/O devices 212 include a keyboard, mouse, sensors, diagnostic equipment, speakers, interface devices, and other types of peripherals. The network interface 215 may be embodied as any communication circuit, device, or combination thereof, capable of enabling communications over a network between the computing server 102 and other devices (e.g., the client device 110). The network interface 215 may be configured to use any one or more communication technologies (e.g., wired or wireless communications) and associated protocols (e.g., Ethernet, Bluetooth, WiFi, etc.) to perform such communication.

Illustratively, the memory 220 includes the referral tool 104 and the web service application 106 discussed relative to FIG. 1. The storage 230 includes the database 108. The database 108 may be embodied as any relational database that stores treatment center data collected from various sources. Further, the database 108 may include a variety of tables used to manage the treatment center data and referral tool 104 user and admin data. For example, the database 108 may include data dictionary tables used to convert SAMHSA variable names to human-readable titles and labels. Another example includes category tables that group SAMHSA data items into organized categories. The database 108 may also include user tables for controlling site access, permissions, and roles. The database 108 also includes tables for creating hierarchies of managers and administrative users. The database 108 also includes tables for organizing medical practices into groups and affiliated organizations. In some embodiments, the referral tool 104, web service application 106, and the database 108 may be implemented using the PHP and/or MySQL architecture. In addition, the web service application 108 may be implemented under a variety of web application frameworks, such as Bootstrap. Further, web page scripts executed by the web service application 108 may be implemented using varies script libraries, such as jQuery.

Although FIG. 2 depicts the referral tool 104, web service application 106, and the database 108 as being included in a single computing server 102, one of skill in the art will recognize that each of these components may be configured in separate computing servers 102 or in different combinations. For example, the referral tool 104 and web service application 106 may execute in a given server, and the database 108 may reside in a separate dedicated storage server.

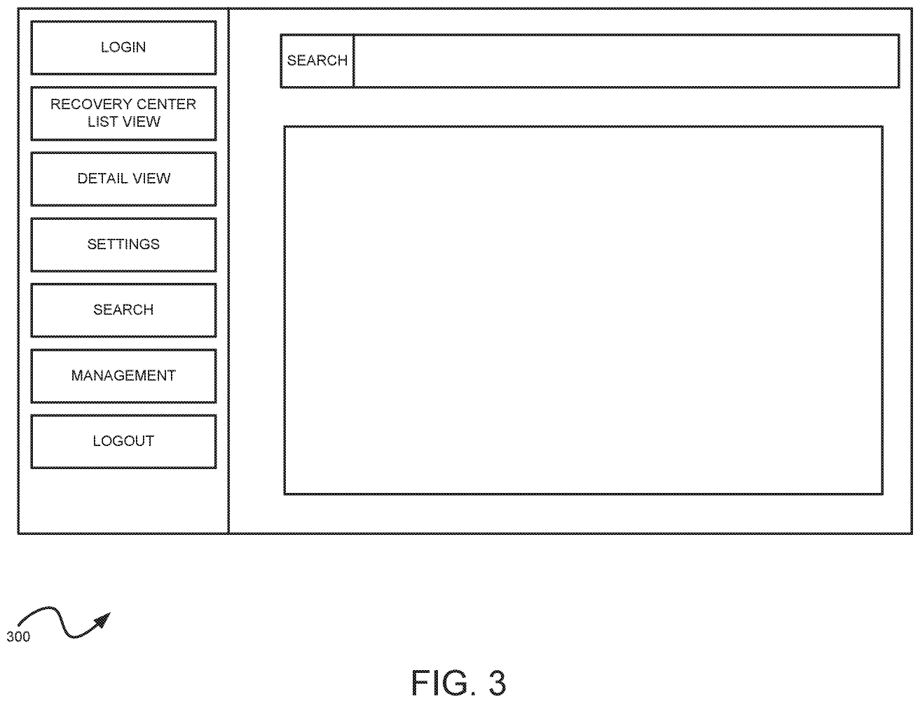

FIG. 3 illustrates an example graphical user interface (GUI) 300 that may be provided to a client device (e.g., by the browser application 112) via the web service application 106 by the computing server 102. The GUI 300 provides an example of features that may be presented to a client device 110. In practice, the GUI 300 may include additional or fewer features. In the illustrative GUI 300, various features are shown, such as a login button, recovery center list view button, a detail view button, a settings button, a search button, a management button, and a logout button.

The login button enables login features to the referral tool 104 and web service 106, e.g., by credentials such as a user e-mail and password. This limits access to authorized users, establishes an affiliation of a user with a particular medical practice, and sets the location of that practice as the default location for ordering the recovery center list proximity sorting. Also, user roles and permissions are established for manager and administrative roles.

The recovery center list view button provides a listing of recovery centers organized by proximity to a location. Each list item includes a center name followed by address, phone number, and distance from a proximity index location. Each item also includes a hyperlink to a detail view. The detail view displays the center address, contact information, features, and policies. The detail view also includes a map which displays the center location visually. A button may be included with this page that allows the health care provider to make a recommendation. Clicking a recommendation button (not shown) generates a printout of the center information, including the name, address, contact information, and the location map.

The settings button enables display of a panel used for entering patient requirements for identifying an appropriate recovery center recommendation. These requirements correspond to the recovery center features found in a SAMHSA data set and include items related to patient demographic information, patient treatment needs, patient family considerations, patient payment options, and other information. Once the settings are established, the recovery center list is filtered to include only those centers that meet the patient requirements. The list of available requirements settings can be filtered by administrative users to reduce the complexity of the settings panel for health care providers.

The search button enables a text input box on a tool bar to allow users to enter a text string that is used to filter the list. The search will filter the list based on the center name and can be used to quickly find a particular center by name. The search option also allows results to be sorted by various criteria, including zip code.

The logout button ends a user session. The management button navigates the user to a management view. The management view may differ based on permissions. For example, a manager permission allows a user to oversee a specific location of a medical practice or organization and create, edit or delete user accounts for that location. An admin permission allows a user to oversee multiple locations for a medical practice or health organization. The admin permission allows the user to create, edit, or delete user accounts for any location within the organization. A user with admin permissions can create manager permissions for another user. Further, a user with admin permissions can create, edit or delete locations for the organization. As another example, a super-admin permission allows a user to oversee all the medical practices and health organizations using the referral tool 104 and create, edit or delete new organizations, and can be used to create, edit or delete admin permissions and accounts.

The main window of the GUI 300 may provide listings of recovery resource locations such as treatment centers, e.g., as a sorted scrolling list. The listings may display an Institution Name, Street Address, Contact Person, Phone Number, and E-mail Address, and be sorted by name or location proximity. Further, a detail page may be displayed in the main window and provide extended information for each listing, such as information about the programs provided, cost, insurance accepted, and the like.

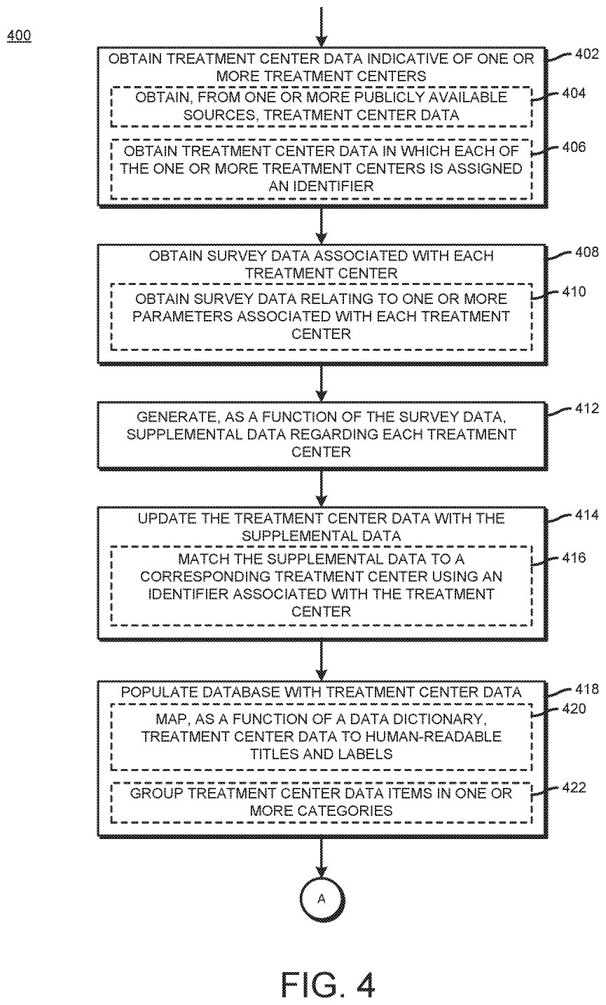

FIG. 4 illustrates an example flow diagram of at least one embodiment of a method 400 for building a database of treatment center data (e.g., database 108) used by the referral tool 104. As shown, the method 400 begins in block 402, in which the referral tool 104 obtains treatment center data indicative of information relating to one or more treatment centers. For example, in block 404, the referral tool 104 may obtain the treatment center data from one or more publicly available sources, such as the SAMHSA website. To do so, the referral tool 104 may scrape the source and execute one or more natural language processing algorithms to parse and organize the data. In addition, in block 406, the referral tool 104 may obtain the treatment center data and assign each treatment center in the data a given identifier. The identifier may be, for example, a universally unique identifier (UUID), such that identifiers are distinct between differing treatment centers.

In block 408, the referral tool 104 obtains survey data associated with each treatment center in the treatment center data. The survey data may be user-submitted (e.g., by a health care provider of a given treatment center), e.g., via an online portal provided by the web service application 106. Also included in survey data may be a separate collection of data by a given treatment center. Primary data collection includes contacting health care clinics and hospitals by telephone, mail, and/or electronically and conducting structured interviews. During these interviews, data clerks verify 1) hours each provider spends in direct patient care, 2) the setting of the provider's practice, 3) whether he or she provides addictions treatment services, and 4) if and to where patients are referred for addiction treatment services. Further, in block 410, the referral tool 104 may obtain survey data relating to one or more parameters associated with each given treatment center. For example, parameters associated with a treatment center include contact information (e.g., name, phone, address, website), navigation services coordinates, genders treated, age groups treated, treatment setting (e.g., outpatient, outpatient for specified substances, general hospital, etc.), type of care offered (e.g., substance abuse treatment, detoxification, maintenance, etc.), treatment approaches offered (e.g., cognitive therapy, dialectical therapy, counseling, relapse prevention, etc.), ancillary services offered (e.g., various substance detoxification, gambling disorder treatment, family counseling), payment accepted, and so on.

In block 412, the referral tool 104 generates, as a function of the survey data, supplemental data regarding each treatment center. For example, to do so, the referral tool 104 may identify correlations and deltas between information provided by publicly available sources and information specified in the survey. In block 414, the referral tool 104 updates the treatment center data with the supplemental data. For instance, to do so, in block 416, the referral tool 104 matches the supplemental data to a corresponding treatment center using an identifier associated with the treatment center. More particularly, the survey data may specify an identifier associated with the treatment center, and the generated supplemental data may retain that identifier.

In block 418, the referral tool 104 populates the database 108 with the treatment center data. For instance, to do so, in block 420, the referral tool 104 maps, as a function of a data dictionary, the treatment center data to human-readable titles and labels. The data dictionary may be embodied as one or more tables that converts SAMHSA variable names to such human-readable titles and labels. Further, in block 422, the referral tool 104 may group treatment center data items into one or more categories. In an embodiment, the database 108 includes category tables that group the SAMHSA data items into organized categories.

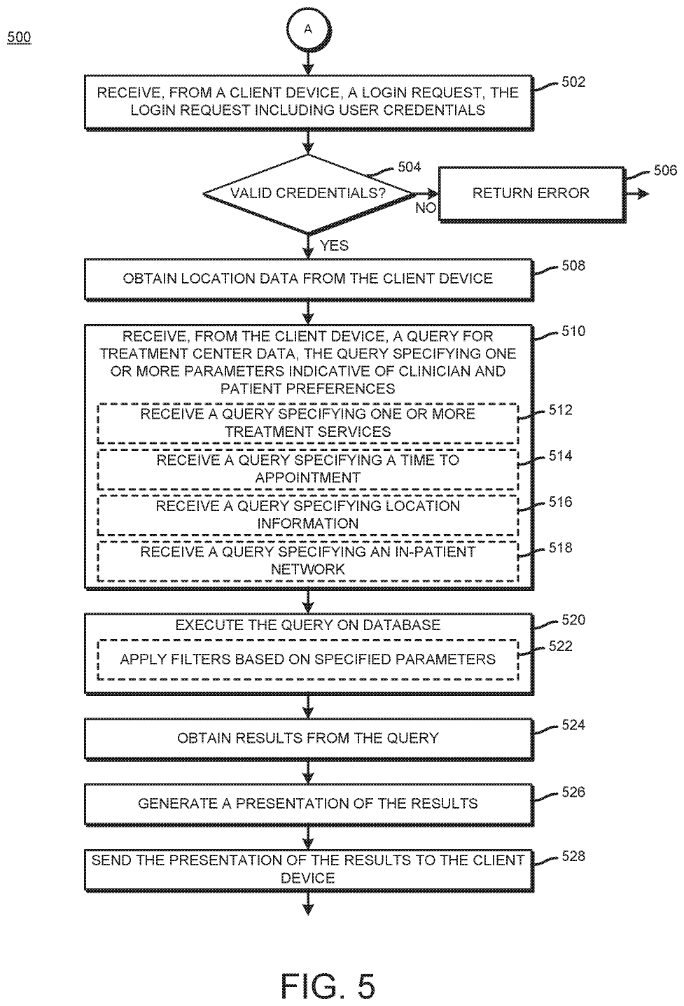

FIG. 5 illustrates an example flow diagram of at least one embodiment of a method 500 for providing treatment center options responsive to a search query via the referral tool 104 and web service application 106. As shown, the method 500 begins in block 502, in which the web service application 106 receives, from the client device 110 (e.g., via the browser application 112), a login request. The login request includes user credentials (e.g., a username and a password). The web service application 106 may validate the credentials (at block 504). If the credentials are invalid, the web service application 106, in block 506, may return an error to the client device 110. Otherwise, the method 500 proceeds to block 508, in which the web service application 106 authenticates the client device 110 and obtains location data from the client device 110. For example, the web service application 106 may include a geocoding application programming interface (API) to obtain a street address from geolocation coordinates provided by the client device 110. The web service application 106 may transmit the location data to the referral tool 104. The location data obtained from the client device 110 may be used to sort list results once retrieved in response to the query (e.g., results may be sorted by proximity).

In block 510, the web service application 106 receives from the client device 110 a query for treatment center data (e.g., stored in the database 108). The query specifies one or more parameters that may be indicative of clinician and/or patient preferences. For example, in block 512, the web service application 106 may receive a query specifying one or more treatment services. As another example, in block 514, the web service application 106 may receive a query specifying a time to appointment (e.g., based on an amount of hours, days, weeks, etc.). As yet another example, in block 516, the web service application 106 may receive a query specifying location information. The location may be user-specified or automatically provided by the client device 110 based on the obtained location data. As another example, in block 518, the web service application 106 may receive a query specifying a given in-patient network. Of course, the query may include any combination of the above described parameters as well as additional parameters not mentioned relative to method 500.

In block 520, the web service application 106 executes the query on the database 108. In block 522, the web service application 106 may apply one or more filters based on the specified parameters. In block 524, the web service application 106 obtains results from the query. In block 526, the web service application 106 generates a presentation of the results. For example, the web service application 106 may generate a markup language file (e.g., a hypertext markup language (HTML) file, eXtensible markup language (XML) file) including the query results. In block 528, the web service application 106 sends the presentation of the results to the client device 110, which in turn may display the presentation of the results. A health care provider may, for instance, print the results, email the results to a patient, and/or the like. In some cases, information about the query may be tracked to monitor changes in follow-up treatment rates and workforce. For example, specified parameters in each query may be tracked and incremented each time a user invokes the parameters.

The techniques described may also be implemented, e.g., on a system that has a processor and a memory that stores program code, which, when executed on the processor, performs the functions of the treatment center referral tool. The techniques may also be implemented via a computer-readable storage medium storing instructions, which, when executed on the processor, performs the functions of the treatment center referral tool.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

What is claimed is:

1. A computer-implemented method, comprising:
obtaining, by execution of one or more processors, treatment center data indicative of one or more treatment centers;
generating, as a function of survey data obtained for each of the one or more treatment centers, supplemental data regarding each of the one or more treatment centers;
updating the treatment center data with the supplemental data; and
populating a database with the updated treatment center data.

2. The computer-implemented method of claim 1, wherein obtaining the treatment center data indicative of the one or more treatment centers comprises obtaining, from one or more publicly available sources, the treatment center data.

3. The computer-implemented method of claim 1, wherein obtaining the treatment center data indicative of the one or more treatment centers comprises obtaining the treatment center data, wherein each treatment center is assigned an identifier.

4. The computer-implemented method of claim 3, wherein updating the treatment center data with the supplemental data comprises matching the supplemental data to a corresponding one of the treatment centers using the identifier associated with the treatment center.

5. The computer-implemented method of claim 1, wherein populating the database with the treatment center data comprises mapping, as a function of a data dictionary, the treatment center data to human-readable titles and labels.

6. The computer-implemented method of claim 1, wherein the treatment center data comprises a plurality of items, and wherein populating the database with the treatment center data comprises grouping each of the plurality of items in one or more categories.

7. The computer-implemented method of claim 1, further comprising:
receiving, from a client device, a query for the treatment center data, the query specifying one or more parameters;
executing the query on the database;
obtaining results from the query; and
returning the results to the client device.

8. The computer-implemented method of claim 7, wherein returning the results to the client device comprises:
generating a presentation of the results; and
sending the presentation of the results to the client device.

9. The computer-implemented method of claim 7, wherein receiving, from the client device, a query for the treatment center data comprises receiving a query specifying one or more treatment services.

10. The computer-implemented method of claim 7, wherein receiving, from the client device, a query for the treatment center data comprises receiving a query specifying location information.

11. A non-transitory computer-readable storage medium comprising instructions, which, when executed on one or more processors, performs an operation comprising:
obtaining treatment center data indicative of one or more treatment centers;
generating, as a function of survey data obtained for each of the one or more treatment centers, supplemental data regarding each of the one or more treatment centers;
updating the treatment center data with the supplemental data; and
populating a database with the updated treatment center data.

12. The non-transitory computer-readable storage medium of claim 11, wherein obtaining the treatment center data indicative of the one or more treatment centers comprises obtaining, from one or more publicly available sources, the treatment center data.

13. The non-transitory computer-readable storage medium of claim 11, wherein obtaining the treatment center data indicative of the one or more treatment centers comprises obtaining the treatment center data, wherein each treatment center is assigned an identifier.

14. The non-transitory computer-readable storage medium of claim 11, wherein populating the database with the treatment center data comprises mapping, as a function of a data dictionary, the treatment center data to human-readable titles and labels.

15. The non-transitory computer-readable storage medium of claim 11, wherein the operation further comprises:
receiving, from a client device, a query for the treatment center data, the query specifying one or more parameters;
executing the query on the database;
obtaining results from the query; and
returning the results to the client device.

16. The non-transitory computer-readable storage medium of claim 15, wherein returning the results to the client device comprises:
generating a presentation of the results; and
sending the presentation of the results to the client device.

17. The non-transitory computer-readable storage medium of claim 15, wherein receiving, from the client device, a query for the treatment center data comprises receiving a query specifying one or more treatment services.

18. The non-transitory computer-readable storage medium of claim 15, wherein receiving, from the client device, a query for the treatment center data comprises receiving a query specifying location information.

19. A computing server, comprising:
one or more processors; and
a memory storing program code, which, when executed by the one or more processors, performs an operation comprising:
obtaining treatment center data indicative of one or more treatment centers,
generating, as a function of survey data obtained for each of the one or more treatment centers, supplemental data regarding each of the one or more treatment centers,
updating the treatment center data with the supplemental data, and
populating a database with the updated treatment center data.

20. The computing server of claim 19, wherein the operation further comprises:
receiving, from a client device, a query for the treatment center data, the query specifying one or more parameters;
executing the query on the database;
obtaining results from the query; and
returning the results to the client device.
